(19) United States
(12) Patent Application Publication
(10) Pub. No.: US 2002/0065720 A1
(43) Pub. Date: May 30, 2002

(54) Online promotion redemption control

(76) Inventors: Rufus H. Carswell, Atlanta, GA (US); Lucian Kapuscinski, Atlanta, GA (US)

Correspondence Address: HINKLE & O'BRADOVICH, LLC, 395 SCENIC HIGHWAY, LAWERENCEVILLE, GA, 30045, US

(21) Appl. No.: 09/962,540

(22) Filed: Sep. 25, 2001

Related U.S. Application Data
(63) Continuation-in-part of application No. 09/618,662, filed on Jul. 18, 2000.
(60) Provisional application No. 60/235,769, filed on Sep. 26, 2000.

(51) Int. Cl. G06F 17/60

(52) U.S. Cl. 705/14

(57) ABSTRACT

A method and apparatus for managing online promotions is disclosed. A coupon issuing server is used to provide promotions in the form of certificates, coupons, tickets and any other offer on a network that can be downloaded and redeemed either on paper or electronically. The server provides software to computers on a network. The software is used to identify individual computers and to allow the individual computer only one copy of each of the promotions thereby preventing multiple copies of a promotion to be used by any one user.

### CROSS-REFERENCE TO RELATED APPLICATIONS

This application is a continuation-in-part of co-pending U.S. Utility patent application No. 09/618,662, filed on Jul. 18, 2000, entitled “Fraud Resistant Electronic Coupon Dispensing System”, and further relates and claims the priority benefit of U.S. Provisional Patent Application No. 60/235,769 filed on Sep. 26, 2000, entitled “Fraud Resistant Electronic Coupon Dispensing And Redemption Control System”.

### BACKGROUND OF THE INVENTION

I. Field of the Invention

The present invention relates generally to the field of redeemable product discount coupons, and more particularly to systems for generating and redeeming product discount coupons over public computer networks, such as the Internet, thereby providing a security system to prevent the unauthorized issuance of multiple coupons from a single computer and to detect copied coupons.

II. Description of the Related Art

The ability of a consumer to print coupons on a home computer and printer from a public network such as the Internet has existed for some time. It has been observed that most businesses presently offering coupons are small businesses with a direct relationship with their customers. There are virtually no packaged goods manufacturers offering product discount coupons at the present time because there exists a lack of security from dishonest intermediaries, typically grocery and drug store managers and owners. The basic lack of security for this market stems from the fact that multiple copies of the same coupon can easily be printed on the home computer or copies of one coupon can be made from a single printed coupon. As coupons, particularly manufacturer's coupons, have both monetary value and barter value, there are those dishonest intermediaries who try to cheat the system. For example, a “50 cents off” coupon is presented by a customer to a store, and the store credits the customer 50 cents on the purchase of the product. The store then turns in the “50 cents off coupon to the manufacturer and receives 50 cents in cash. In the volume that coupons are issued, fraud can impose a large negative financial impact on a manufacturer or coupon redeemer. Packaged goods manufacturers and some other coupon issuers do not use public computer network produced coupons because they have to work through an intermediary leaving the major corporation open to potentially dishonest intermediaries who may be inclined to redeem bogus coupons and receive large amounts of cash or other consideration from the coupon issuing corporation.

There are various types of electronic coupon communication systems known in the art for issuing product discount coupons, and there are systems for redeeming these coupons electronically. Essentially, the long developed procedure for utilizing product discount coupons on packed goods generally starts with a coupon in paper form which contains an industry standard bar code, the Universal Product Code (“UPC Code”) that contains the assigned product description number and other necessary information. The coupon is then put into the hands of the consumer by any number of methods such as direct mail, written media inserts and the like. The consumer then takes the coupon to the store where the consumer purchases the product, and receives the discount noted on the coupon at the point of sale. Subsequently, the store clerk who handles the coupon at the point of sale scans the coupon bar code into the store computer, or the coupon can be later scanned at a location rather than the point of sale. The information from the coupon UPC Code is logged into a store database that note the product and how much the manufacturer owes the store for the discount. The store then bags or packs all the coupons it has received (typically unsorted) and sends the coupons to a coupon clearinghouse/redemption center in which the store has under contract for that purpose. The clearinghouse runs the unsorted coupons through a bar code scanner, which sorts the coupons and determines the product manufacturer's contracted coupon clearinghouse and sends these sorted, scanned coupons to the respective clearinghouses. At this point, the manufacturer's clearinghouse receives the coupons and again runs them through a bar code scanner that records the necessary information contained in the bar code, such as the name of the manufacturer, the product number, the amount of the discount and other like information, and then the manufacturer's clearinghouse calculates the amount owed to the individual store and returns a check for that amount to the respective store. The clearinghouse then typically invoices the amount paid to the manufacturer, plus any other charges as applicable.

Typical of the practice just described, is the patent to Jovicic et al. (U.S. Pat. No. 5,855,007) that shows an electronic coupon communication system much as just described. The system of this patent requires a separate server and database to log coupon serial numbers and this server database system must be contracted when the coupon is made and when it is redeemed, but, more importantly, the system of Jovicic does not have a full security system for determining and preventing the issuance of multiple coupons and the redemption thereof. This particular patent has a coupon verification system that includes verifying the validity of an electronic coupon at a redemption center by accessing the computers network notification center's coupon generation database, but does not discriminate between coupons that may have been printed on a multiple basis from a single computer. Therefore, the security system of this particular patent fails to eliminate the production of multiple coupons from a single source.

### SUMMARY OF THE INVENTION

In accordance with the present invention and the contemplated problems which have and continue to exist in this field, the invention provides a system and method for issuing online promotions such as coupons over public computer networks, solving the problem of security with respect to a consumer or a store owner/employee attempting to redeem multiple coupons from a single computer. The present invention addresses the security problem on the front end of the system of issuing coupons by a method to allow one and only one coupon to be printed from a single computer. While this can still allow a consumer to make multiple copies of that printed coupon, the present invention combats the security problem on the back end of the coupon issuing system by having a second security method that detects copied coupons.

In one aspect the invention features a promotion issuing system that includes a first computer connected to a network, the first computer having a memory, at least one additional computer connected to the network, the at least one additional computer having a memory and a first process that resides in the memory of the first computer with instructions to distribute a promotion on the network, identify the downloading of the promotion by the at least one additional computer, allow the at least one additional computer to download the promotion and terminate any further attempts by the at least one additional computer to download the promotion any additional times.

In an implementation, the system also includes an additional process residing in the memory of the at least one additional computer where the additional process has instructions to record a unique identifier associated with the promotion about the promotion and communicate with the first process in the determination to allow the download if the cookie has been recorded and to terminate the download if the cookie has been recorded any additional times, or alternatively identify the user each time the at least one additional computer attempts to download the promotion, allow the at least one additional computer to download the promotion if it has been identified once and terminate any additional downloads if the at least one additional computer has been identified more than once.

In another implementation, the system includes a data structure stored in the memory of the first computer and a copy of the data structure stored in the at least one additional computer.

In another implementation, the first computer is adapted to allow the at least one additional computer to download the promotion and record the copy of the data structure and terminate any further download attempts made by the at least one additional computer if the data structure is recorded in the memory of the first computer any additional times.

In yet another implementation, the system includes a device coupled to the first computer and the at least one additional computer, the device being adapted to disallow more than one download of the promotion by the at least one additional computer.

In another aspect, the invention features a method of managing online promotions including using a first computer to distribute promotions on a network, wherein the promotions are adapted to be downloaded by computers, tracking each of promotions that are downloaded on one or more of the computers and identifying and terminating attempts to download any one of the promotions more than once on any one of the computers.

In an implementation, the promotions are available to one or more of a plurality of network locations such as web sites.

In another implementation, the promotions are tracked by a process that resides on one or more of the computers.

In another implementation, the method stores unique identifiers associated to each of the promotions on the first computer.

In still another implementation, identifying and terminating attempts to download the promotion more than once includes allowing any one of the computers to download any one of the promotions if the process matches its identifier with the identifier in the first computer and disallowing any one of the computers to download any one of the promotions if the process matches its identifier with the identifier in the first computer any additional times.

In yet another implementation, the method includes using the process to identify components of each of the computers and storing data corresponding to the components in the process and on the first computer.

In another implementation, identifying and terminating attempts to download the promotion more than once includes allowing any one of the computers to download any one of the promotions if the data corresponding to the components matches with the data corresponding the components on the first computer and disallowing any one of the computers to download any one of the promotions if the data corresponding to the components matches with the data corresponding to components on the first computer any additional times.

In another implementation, each of the promotions is tracked by a file that resides on one or more of the computers.

In another implementation, each of the promotions is tracked by a device coupled to the first computer and to each of the other computers.

In another implementation, the method includes limiting the duration that the promotion can be validly downloaded by one or more of the computers.

In another implementation, the method includes associating a second unique identifier with each of the plurality of promotions, determining if there exists a copy of any one of the plurality of promotions and disallowing the copy to be redeemed.

In still another aspect, the invention features a method of preventing abusive use of an online promotion, including providing the promotion with a unique identifier, distributing security software to a computer that is attempting to download the promotion, using the security software to record the identifier, denying a download if the security software has recorded the identifier more than once, optionally printing the promotion if the download has not been denied and checking the printed promotion for copying.

In another aspect, the invention features a promotion misredemption control system, including a device adapted to receive promotion data and a process located on the device having instructions to receive and store the promotion data on the device, compare the promotion data with previous data and generate a signal if a misredemption is detected.

In one implementation, the device is a computer on a network.

In another implementation, a central server is connected to the network.

In another implementation, the previous data is in the computer received from the central server.

In another implementation, the signal is generated if the promotion data matches the previously stored data.

In another aspect, the invention features a misredemption control system, including a central server connected to a network, at least one additional computer connected to the network and a database connected to the network, the database including promotional information.

In one implementation, the system includes copies identifying information data stored in the database.

In another implementation, the computer is adapted to receive identifying information.

In another implementation, the server is adapted to receive the identifying information from the computer and compare the identifying information to the copy of the identifying information.

In another implementation, the server is adapted to generate a message for the computer that the identifying information has matched the copy of the identifying information.

In another implementation, the computer is adapted to generate a misredemption signal based on the message.

In another aspect, the invention features a method for the prevention of promotion misredemption, including providing identifying information on a promotion, storing a copy of the identifying information, distributing the promotion, receiving the identifying information when the promotion is presented for redemption and comparing the identifying information to the copy of the identifying information.

In one implementation, the method further includes optionally rejecting the promotion if the identifying information does not match the copy of the identifying information.

In another implementation, the method further includes optionally accepting the promotion if the identifying information matches the copy of the identifying information.

In another implementation, the copy of the identifying information is stored on a central server on a network.

In another implementation, the identifying information is received by a computer on a network.

In another implementation, the server compares the identifying information to the copy of the identifying information.

In another implementation, the server generates a misredemption message if the identifying information and the copy of the identifying information do not match.

In another implementation, the computer generates a misredemption signal based on the misredemption message.

In another implementation, the method further includes generating a message indicating whether the promotion is acceptable for redemption.

In still another implementation, the method includes generating a signal if a misredemption is detected.

One advantage of the invention is that the systems and methods described overcome the difficulties of the prior art in that they work within the long established coupon issuing arrangement used by packaged goods manufacturers, and other coupon issuers, and requires no additional equipment to be purchased by the manufacturer, the retail store or the coupon clearinghouse. The present invention does require that the coupon clearinghouse make a minor modification to its UPC Code reading and logging software to possibly read additional digits within the bar code which relate to a discrete serial number on each coupon, or other identifying data. Not every coupon clearinghouse requires such a modification, but only those who contract with packaged goods manufacturers using the coupon issuing system covered under the invention.

A feature of the invention is the ability to identify a single computer and to know that such single computer has received a specific coupon. The identification of the single coupon issuing computer is the front end portion of the present system, and such a computer is identified by the invention by one of several methods including but not limited to installing a cookie including a serial number on the printing computer allowing a server to access the cookie, using a query program allowing information about the recipient's computer to be queried, and by identifying hardware.

Another security aspect of the invention is the back end of the coupon issuing system which detects copied coupons. The security feature includes a unique identification (I.D.) or serial number printed on the issued coupon and imbedded in the bar code. By this method of security on the back end of the coupon issuing process, the product manufacturer has control over the numbers of coupons that have been issued, thus limiting the manufacturer's liability for payment.

Other objects, advantages and capabilities of the invention will become apparent from the following description taken in conjunction with the accompanying drawings showing the preferred embodiment of the invention.

### BRIEF DESCRIPTION OF THE DRAWINGS

FIG. 1 illustrates an embodiment of a coupon issuing system;

FIG. 2 illustrates a process flow diagram of an embodiment of an operational sequence of a processing and redemption of an issued coupon;

FIG. 2B illustrates a promotion distribution and tracking process;

FIG. 3 illustrates an embodiment of a product manufacturer's web site distribution arrangement;

FIG. 4 illustrates an embodiment of a self-standing multiple coupon web site distribution arrangement;

FIG. 5 illustrates an embodiment of an Internet recipe web site distribution arrangement;

FIG. 6 illustrates an embodiment of a specially engineered Internet web page distribution arrangement;

FIG. 7 illustrates an embodiment of an e-commerce retail web site distribution arrangement;

FIG. 8 illustrates an embodiment of a user placed promotion distribution arrangement;

FIG. 9 illustrates an embodiment of a network coupon having security features;

FIG. 10 illustrates an embodiment of a promotion misredemption control system;

FIG. 11 illustrates another embodiment of a promotion misredemption control system; and

FIG. 12 illustrates still another embodiment of a promotion misredemption control system.

### DETAILED DESCRIPTION OF THE INVENTION

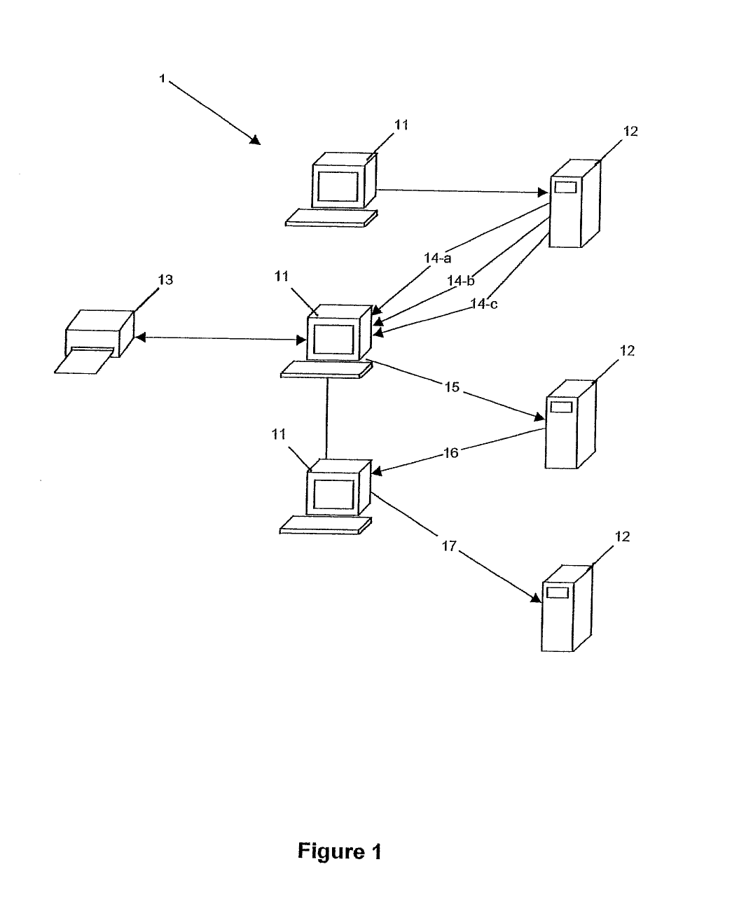

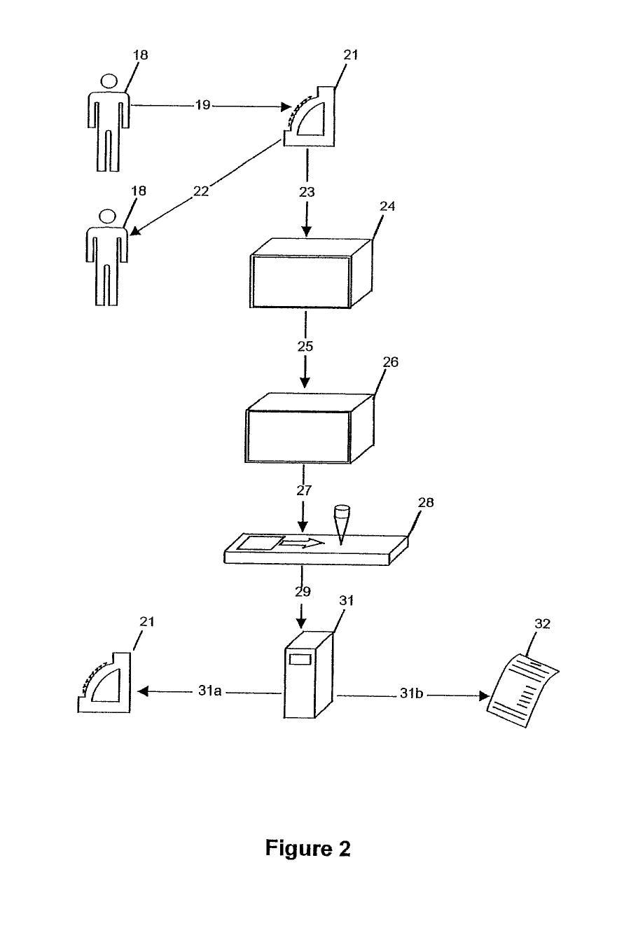

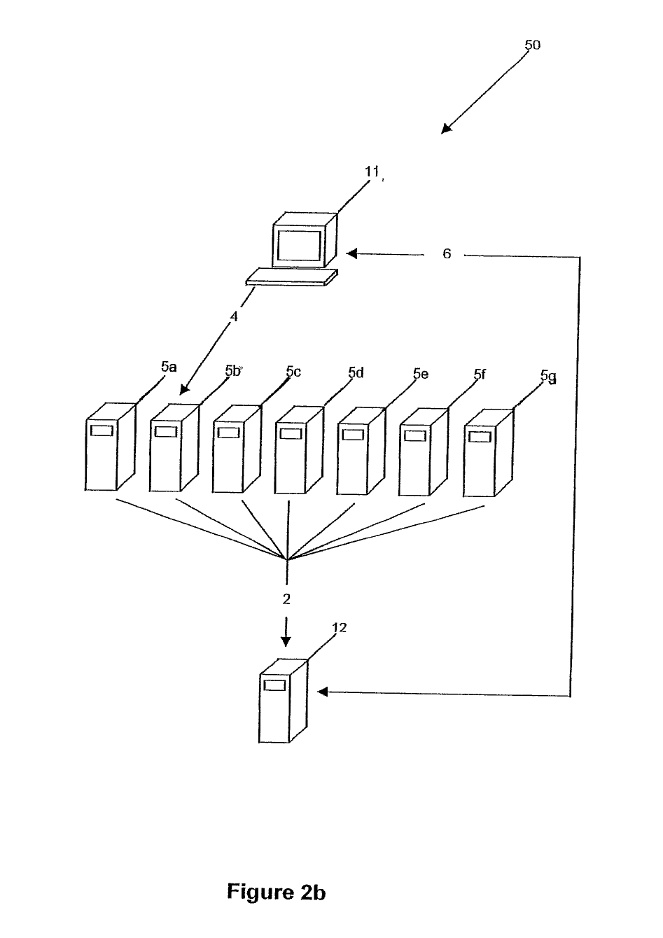

Referring to the drawings wherein like reference numerals designate corresponding parts throughout the several figures, reference is made first to FIGS. 1 and 2 that illustrate an embodiment of a coupon issuing system and an embodiment of the operational sequence of a coupon issuing and processing process, respectively. The term promotion is typically used below and includes any offer made on the network such as a coupon, certificate or any offer that can be used to discount a product and can be redeemed for value. For simplification, the process flow diagram of FIG. 2 is shown in block format and are described herein. When the consumer who wishes to be issued a coupon makes an initial request though the consumer's computer 11 to the computer network server (not shown) where the coupon has been placed by the product manufacturer, the consumer's computer 11 asks the coupon issuing server 12 to print a coupon to the recipient's computer printer 13.

### Front End Security

The identification of a single issuing computer 11 is the front end security feature of the system shown in FIG. 1. The computer 11 can be identified by many methods.

The first method of identification of a single coupon issuing computer 11 is by installing on the computer 11 a “cookie” that is a small program that can be sent by the coupon issuing server 12 or another server or device for that purpose, through the public computer network or any linked computer system, including television receivers, and any other device connected to the public computer network. The cookie resides on the receiving unit's system (e.g., computer 11) until removed. The installed cookie includes a code or serial number that can be accessed by the server 12 to identify that particular receiving computer 11 or device. The coupon issuing server may record the identified computer 11 or device in a database. In one implementation, the cookie can record the issued coupon and relay that information to the coupon issuing server 12 if the server 12 requests that information from the cookie. Once it has been determined that a particular coupon has been issued to the identified computer 11 or device, the system does not allow another of the same coupon to be issued to the identified computer 11 or device.

The coupon issuing server 12 sends the cookie to reside on the recipient computer's memory as indicated by arrow 14a. The cookie is one of the several methods to accomplish the identification of a single computer.

Another method of identification of a single coupon printing computer (e.g. computer 11) is by using a query program. The coupon issuing server 12 can send a software program, as indicated by arrow 14b, to reside on the recipient's computer 11 over the public computer network or linked system. This program has the ability to query hardware components for their manufacturer's name, model number, serial number and other available information.

From this query, a profile can be developed and kept in raw data form, or calculated into an identifying number that will represent a particular computer such as computer 11 to the coupon issuing server 12. This information can reside either within the query program located within the recipient's computer or it can be transmitted back to the coupon issuing server 12 and stored in a database (not shown). The coupon issuing server 12 uses this information to record all coupons issued to the computer 11 and denies all requests from the recipient's computer 11 to print more than one of any individual coupon. In an implementation, the query program, residing on the recipient's computer 11, records the issued coupon and relays the information to the server 12 should the information be requested from the program by the server 12. In one embodiment, the query program can be used as a cookie or it can be a separate process that can be downloaded from the coupon issuing server 12 by the computer 11. In another embodiment, downloading of this process can be a requirement before a coupon is issued by the server. If the program is not downloaded, then the computer 11 is not able to receive an issued coupon from the server 12.

Another method for identification of a single computer is by additional identifying hardware. Any hardware that has the capability to provide an individual identifying number and/or name to the coupon issuing server 12 can be used by the secured coupon issuing system as the method for identifying an individual computer indicated by arrow 14c. The coupon issuing server 12 sends the initial page of the coupon issuing software to begin the coupon printing sequence. A unique I.D. or serial number is assigned to the coupon by the server. In an implementation, the serial number can be an alphanumeric number to be printed on the coupon and/or can be placed in he UPC extended bar code co that it can be read by bar code scanning equipment.

An additional method for identification of a single computer is for the server 12 to send a file containing a unique identifier to the computer 11. When the coupon issuing system 1 needs to identify an individual computer it finds the file and checks the identifier with an identifier database that resides on the server 12 or as a peripheral.

The recipient computer 11 then prints the coupon on the recipient's's printer 13 for subsequent use by the recipient. After printing one coupon, should the recipient attempt to print another coupon (or press the “back” button on a web page) on the recipient's computer screen and try to print another coupon, the recipient's computer browser does not print another coupon due to the security features (as described above) on the recipient's computer 11.

Built into the coupon issuing software is the ability to set a time limit for the coupon offer. Upon reaching the end of the time limit, the coupon issuing software stops issuing coupons. This time limit can be varied from seconds to years through the software interface that is discussed in detail below.

### Back End Security

Another security aspect is the back end of the coupon issuing system 1 that detects copied coupons.

In general, once a coupon is issued the recipient has only to copy the issued coupon on a copying machine and present multiple copies for payment, even though only one actual coupon might be issued by a particular computer. To overcome the security problem with this aspect of the coupon issuing system 1, a security feature that detects copied coupons is incorporated into the system 1. Every issued coupon has a unique I.D. or serial number printed thereon. This I.D. can be in several places on the coupon and can have several formats. In one implementation, the format for the I.D. is an alphanumeric identifier in large type to let people know that the coupon has its own serial number. In another implementation, the same number is also placed in the UPC extended bar code so that it can be read by bar code scanning equipment. The extended UPC bar code has digit space available that can be accessed by a coupon issuer's software and used for identification purposes. Effectively, the issuing server 12 can print a discrete identifying serial number with the UPC bar code that can be read by the requisite UPC bar code scanning equipment, thereby determining whether or not a particular coupon has been presented for redemption. If the matching serial number has been presented for redemption then any copied coupons are automatically rejected. This coupon redemption center scans the coupon for information and obtain the I.D. or serial number. The discrete number is placed in the coupon redemption center's computer, along with any other identified information. In one implementation, the coupon redemption center's computer tracks the I.D. or serial number and notes any duplicates. Such information is then available to the manufacturer in order to proceed as the manufacturer deems appropriate concerning the redemption of the duplicate coupons.

### Preparation of Online Coupons

To facilitate easier construction and preparation of an online coupon, a “construction screen” (not shown) is provided with the coupon issuing software. This construction screen is intended to be used solely by the coupon issuer and possibly by clients. In an implementation, the construction screen is computer protected. The construction screen can contain many features for managing online promotions including but not limited to: a coupon template that provides inputs for all necessary elements of an online coupon (i.e., UPC code, serial number/I.D., etc.) with an outline of the coupon; inputs to enter all the necessary UPC bar code information (computer software generates the code); an input for coupon artwork allowing placement and editing of the artwork; an input for the time limit of the coupon offer; and an entry for the maximum number of coupons to be issued.

In the event that the recipient computer logs off the network and then logs back onto the network, and the recipient then asks the server 12 to reprint the same coupon (as shown by arrow 15) the server 12 queries the cookie, or other identification processes or apparatus, as indicated by arrow 16, of the recipient computer 11 to determine if this specific coupon has been issued by the recipient computer 11. If the computer 11 determines that this specific coupon has been issued previously to this computer 11, it recognizes that previously issued I.D. of the first coupon and reports the same through arrow 17 to the server 12 that, in conjunction with the cookie or other security process or apparatus, installed in the computer 11, refuse to reissue the same coupon.

During the time the coupon offer is in effect, a computer “reporting screen” (not shown) is used to monitor the progress of the offer. This screen is available to the coupon issuer and to the client. Access to this screen is password protected.

The reporting screen can contain many elements including but not limited to: an image of the coupon; a counter that shows that number of coupons issued; the coupon offer beginning and ending date; the maximum number of coupons to be issued; and a control to stop the offer.

Once a coupon offer is complete, the reporting screen shifts to an archive screen (not shown) that is set up for the product's manufacturer. Using a password for entry, the manufacturer is able to view the archive of past promotions.

In the processing of the issued coupon, once the coupon is printed by the recipient's computer 11 and printer 13, then the coupon follows the standard processing routine of manufacturer's product coupons. As shown in FIG. 2, a customer 18 who is the recipient of the coupon takes the coupon to a retail or other establishment 21 shown by arrow 19. The establishment 21 accepts the coupon and gives the customer 18 credit of the face value of the coupon towards the purchase of the item as shown by arrow 22. After accepting the coupon from the customer 18, the establishment 21 internally processes the coupon and sends the coupon to the establishment's redemption center 24, as shown by arrow 23.

The coupon redemption center 24 sorts the various coupons received by it using the UPC extended bar code printed on the coupon and sends the sorted coupons to the appropriate manufacturer's contracted coupon center 26, as shown by arrow 25. At the manufacturer's coupon center 26, the various coupons that have been received by it are processed, as shown by arrow 27, through a bar code scanning device 28 that scans the coupon UPC extended bar code and reads the coupon serial number or other identifying indicia. Once the scanner 28 records the UPC code and coupon number, the information is sent to the redemption center's computer 31, as shown by arrow 29, that has been programmed with the option to note and record duplicate coupon serial numbers. A report is generated and included information such as the amount of payment that is made to the redeeming establishment 21, as shown by arrow 31a, or to issue a violation report 32, as shown by arrow 31b, to the manufacturer for further processing by the manufacturer.

### Coupon Viewing and Dissemination

The coupon issuing system 1 uses a network link from the viewing web page back to the coupon issuing server 12. This link allows the coupon issuing system 1 to have immense distribution capabilities. A promotion can be placed any one place or multiple places on a network (such as the Internet) allowing for dynamic distribution and does not rely upon a static coupon-oriented web site to be presented to the public.

In one embodiment, the link can be an image, such as an icon or button on any particular web page the user is viewing. When this link is clicked upon or selected, the user is linked to the coupon issuing web site where a coupon can be issued. The coupon issuing server 12 first searches for a security/print program on the user's computer 11. The security/print program is a software program that facilitates the printing of the coupon and assists in operating the security features of the system 1. If this program is located and security is verified, a coupon is immediately issued to the user's computer 11 and is printed to the printer 13. If this program is not found, the server 12 concludes that the user is a new user and offers to download and install the security/print program. Upon successful downloading and installation, a coupon is printed.

FIG. 2B illustrates a promotion distribution and tracking process 50. In general, the system in FIGS. 1 and 2 follow the process 50 which shows an overview of the life of the promotion, illustrating the front and back end security of the system. Referring to FIG. 2B, the promotion is made known and available to the public through one or more links 2 from the coupon issuing server 12 with various Internet web site pages 5, identified individually as 5a, 5b, 5c, 5d, 5e, 5f and 5g, all of which are available to the public. A user of the Internet will connect through a computer 11 to one of these various Internet web sites by link 4.

When a link on the web site is activated by the user's computer 11, which will now become the coupon printing computer, the coupon printing computer is connected at 6 to the coupon-issuing server 12. Upon connection of the coupon-issuing server 12 and the coupon printing computer 11, the coupon printing computer 11 makes a request for the coupon offered on the web site in connection 4. The server 12 scans the memory (hard drive) of the coupon printing computer 11 to see if the required coupon security and printing software is installed on the coupon printing computer 11. If the required coupon security and printing software is installed on the coupon printing computer 1 the server 12 proceeds with the coupon issuing and printing process. If the required coupon security and printing software is not found on the coupon printing computer 11, the software is made available to be downloaded from the server 12 onto the coupon printing computer 11. After the software is installed on the coupon printing computer the coupon printing computer 11 is allowed to continue with the coupon issuing and printing process. Once the coupon issuing server 12 is assured the coupon security and printing software is installed on the coupon printing computer 11, the server 12 scans the coupon printing computer's 11 memory, as indicated by arrow 6, for any unique identifiers (cookies, etc.) assigned to individual coupon promotions. If the unique identifier of the requested coupon promotion is not found on the coupon printing computer 11, the server 12 transmits the data making up the requested coupon to the coupon printing computer 11. At the same time the server 12 also transmits the unique identifier associated with the requested coupon to the coupon printing computer 11 to reside in the coupon printing computer's memory. The required coupon security and printing software residing on the coupon printing computer 11 receives this data and proceeds with the printing of the coupon using a printing device connected to the coupon printing computer 11.

If, during the scan of the coupon printing computer's 11 memory by the server 12, the unique identifier of the requested coupon promotion is found on the coupon printing computer 11, the server will not transmit the data making up the requested coupon.

The coupon issuing system 1 is capable of distributing promotions in several ways. Promotion distribution typically occurs on relevant web sites. Promotions can be placed singularly on selected web pages or they can appear whenever a product category key word or a UPC code is mentioned on a web page, and that the coupon issuing system 1 has a current promotion on that item.

Typically, several methods of promotion distribution can be used including but not limited to:

(1) Manual placement of the promotion on the web page.

(2) The use of the ability, through a client side application or customized Internet browser and server side process, to scan a web site's database, should it have one, to locate key words or descriptors within the database that describe or indicate a product for which there is a current coupon promotion. Should such key words or descriptors be found, a coupon can be placed as a link on the screen adjacent or relative to the product shown on the screen.

(3) The use of the ability, through a client side application or customized Internet browser and server side process, to scan the Hyper Text Markup Language (HTML), extensible Markup Language (XML), or Hyper Text extensible Markup Language (HTMXL) code or their derivative works, or any future code that is devised that generates the computer monitor screen copy to locate key words or descriptors within the database that describe or indicate a product for which there is a current coupon promotion. Should such key words or descriptors be found, a coupon can be placed as a link on the screen adjacent or relative to the product shown on the screen.

Several distribution arrangements, as discussed below can use one or more of the promotion distribution methods described in the previous paragraph.

### Product Manufacturer's Web Site

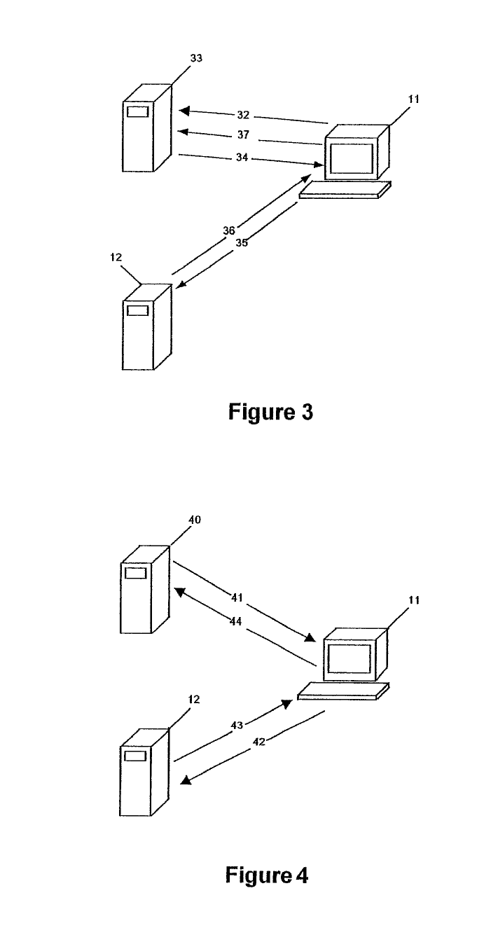

FIG. 3 illustrates an embodiment of a product manufacturer's web site distribution arrangement. Where the product manufacturer has its own web site, the presence of the manufacturer and product is enhanced and opportunities to sell the product are increased. Product coupons offered in the web site act as an reward to the consumer for visiting the site and helps sell and promote the product. A computer 11 is used to view a manufacturers web site, indicated by arrow 34, having a server 33. The manufacturer may place a link anywhere in this web site noting the coupon offer. This link, indicated by arrow 34, when activated, takes the user, as indicated by arrow 35, to a web page located on the coupon issuing server 12 that offers a printable coupon, indicated by arrow 36. This process is generally transparent to the user and the user may not realize that the user has left the manufacturer's web site. After the user prints the coupon using the coupon issuing secure printing software as discussed above, the user is returned to the manufacturer's's web site, indicated by arrow 37, on server 33. All coupons handled in this manner are logged into the coupon issuing server 12 or some other server and is handled as described above.

### Self-standing Multiple Coupon Web Site

FIG. 4 illustrates an embodiment of a self-standing multiple coupon web site distribution arrangement. A self-standing multiple coupon web site is contained on a server 40. A manufacturer can offer the same coupon on the self-standing web site, the manufacturer's web site (e.g., on server 30 in FIG. 3), an online grocery web site (as discussed in more detail below) or any other appropriate web site. All web sites offering the same coupon is linked to a master web site that keeps track of all the coupon offers in all of the locations (e.g., the coupon issuing server 12 in FIG. 1). In another embodiment, the self standing web site can be operated by the coupon issuing server itself (see FIG. 1). In an implementation, the coupon offers can be links that can appear as an image (such as an icon, button or any other graphical element). When the link, indicated by arrow 41, is activated by the user, the user is taken to a web-page located on the coupon issuing server 12, as indicated by arrow 42. If the self-standing web site is located on the coupon issuing server already, the link merely activates the coupon issuing process on the server 12, which issues the printable coupon associated with the link, as indicated by arrow 43. This process is typically transparent to the user and the user may not realize that the user has entered a new web site. After the coupon is printed using the secure coupon printing software (as discussed above), the user is returned to the self standing multiple coupon web site as indicated by arrow 44. The coupons can appear whenever a product category key word or UPC code is mentioned on a web page or other network site, and that there is a promotion available for that product.

A coupon distribution and matching system is used that matches relevant promotions with web pages, such as recipe Internet pages. In one implementation, the coupon issuing software scans a web site database containing product information, recipe information or other pertinent information. In another implementation, the software scans the HTML, XML or HTXML code, or their derivative works, or any future code that is devised, that generate the computer monitor screen copy. In either of the implementations, during the scan the software looks for key product category identifiers such as, but not limited to, words and phrases. When these identifiers are found that match existing promotions, the coupons, for example, associated with the promotion (or the associated symbol or icon) are printed out on the user's printer (e.g., printer 13 in FIG. 1) using the secured coupon printing method discussed above. Other product identifiers such as UPC codes can be used in place of the product category words and the software can scan for the codes.

The following distribution arrangements are embodiments that utilize the coupon distribution and matching system.

### Internet Recipe Web Site

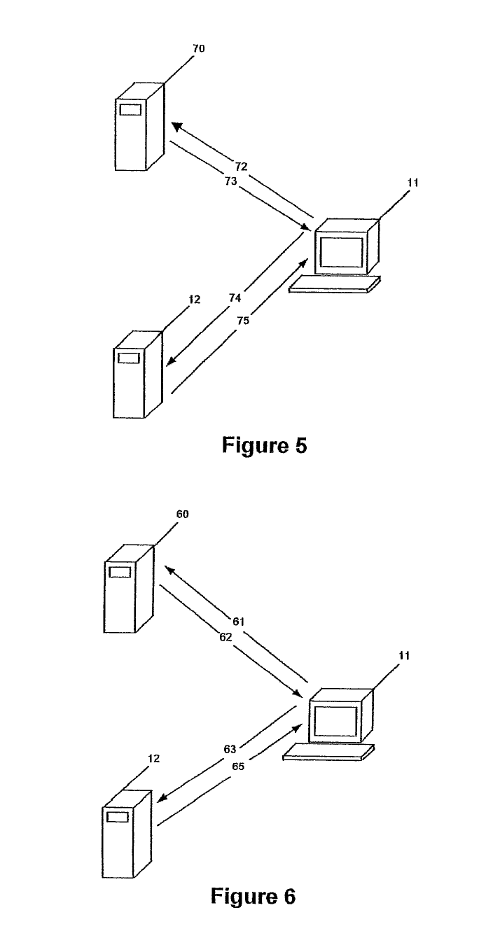

FIG. 5 illustrates an embodiment of an Internet recipe web site distribution arrangement.

A recipe web site located on a server 70 is an exemplary web site that can utilize the coupon distribution and matching system. A recipe web site can contain numerous products, which may be unique, and are associated with a promotion on the coupon issuing server 12. The coupon generating software is similar to the embodiments discussed above. In further embodiments, the software can be placed on the server 70 that operates the recipe web site. This software scans the recipe web site database containing the recipe information or scans the HTML, XML or HTXML code, or derivative works or any future code that is devised that generates the computer monitor screen copy. The software searches for key words or phrases that match with words or phrases located within the software or on the coupon web site server 12. These words or phrases describe food and product categories relevant to the coupon issuing server 12 promotion. When a match is found, a graphical symbol, such as an icon or button or any other graphical element, is shown on the recipe web site web page with the corresponding recipe. When a user on computer 11 who is viewing the recipe web site, as indicated by arrow 72, clicks or otherwise selects the graphical symbol representing the corresponding product match, a link, as indicated by arrow 73, is activated that routes the user to the coupon issuing server 12, as indicated by arrow 74. The coupon issuing server 12 sends a coupon corresponding to the link to the user's computer 11 as indicated by arrow 75. The coupon is then printed using the secure printing software as discussed above. When completed, the user is returned to the web site 70 and web page where the graphical symbol representing the match originated, as indicated by arrow 72.

In one embodiment, all the graphical symbols representing the available promotions, but not the promotions themselves, reside on the recipe web site server 50. Periodic contact takes place over the network or other link between the coupon issuing server 12 and the recipe web site server 50 to provide new data and new promotion symbols and remove those symbols representing expired promotions.

### Specially Engineered Internet Web Pages

FIG. 6 illustrates an embodiment of a specially engineered Internet web page distribution arrangement. A specially engineered web page can allow a manufacturer or any web site operator to offer a user of the respective web site the ability to view unrelated Internet recipe web sites, for example, or other web pages and obtain promotions from the coupon issuing server 12 associated with the ingredients and products shown on the screen. A user on computer 11 views the manufacturer's or web site operator's web site on server 60, as indicated by arrow 61. The user is then offered a graphical symbol inviting the user to an area of the web site where the user may view the unrelated web pages. The web pages offered through this web site area contain recipes or the products for which the user can obtain coupons for those recipes and products shown on the screen. When the user clicks or otherwise selects the symbol associated with the promotion that invites the user to the web site, as indicated by arrow 62, a link, indicated by arrow 63 is activated that takes the user to the specially engineered web page located on the coupon issuing server 12. The specially engineered web page typically appears similar to the manufacturer's or other operator's web site so that the user does not realize that the user has been routed to a different Internet location.

At this new location, the user is able to view web pages located anywhere on the Internet. As the user view the web page, software scans the HTML, XML, or HTXML code or their derivative works, or any future code that is devised, that generates the computer monitor screen copy. The software looks for key words, phrases, or descriptors located within the software or elsewhere on the server 12. The words or phrases describe food and product categories relevant to the coupon issuing server 12 promotion. When a match is found, a symbol representing the available coupon is shown on the specially engineered web page with the corresponding recipe or product.

When the user selects the symbol representing the promotion, the server 12 sends a promotion, indicated by arrow 65, corresponding to the symbol that was selected to the user's computer 11, to be printed on the user's printer user the secure coupon printing software. When the user is finished using the specially engineered web page, the user is returned to the web site and the web page where the user started, as indicated by arrow 61.

Moving the user through the use of a link to the specially engineered web page allows a fast environment—the scanning/matching software operates on a fast server and graphics and information do not need to travel over the Internet. In addition, all the software and promotion offers remain on the coupon issuing server 12 equipment hereby avoiding potential security problems.

### e-Commerce Retail Web Sites

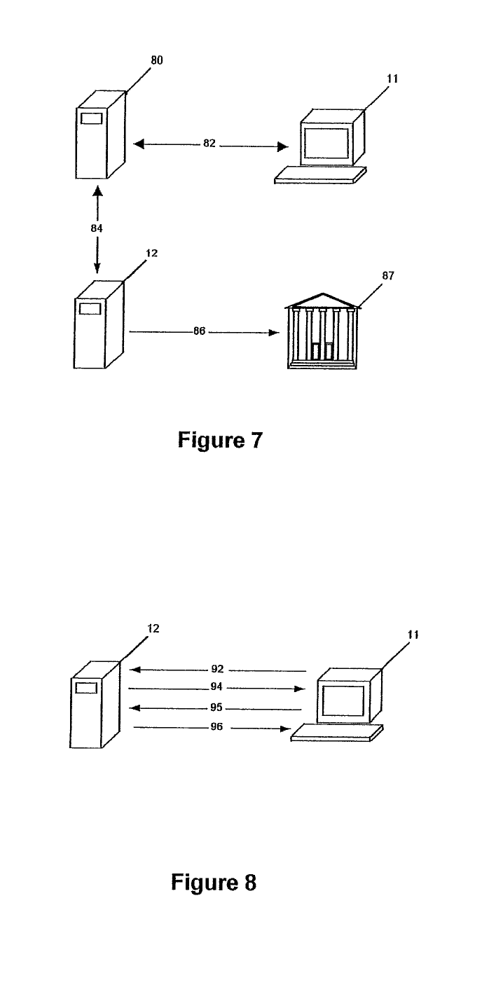

FIG. 7 illustrates an embodiment of an e-commerce retail web site distribution arrangement. While viewing products within a retail web site located on a server 80, a user is able to take advantage of any associated promotions that the server 80 offers. A user on computer 11 viewing the web site on server 80, indicated by arrow 82 sees on the monitor of computer 11 one or more products presented by the retail web site. Coupon issuing software licensed or otherwise distributed to the retail web site operator and residing on the server 80 scans the retail web site database containing product information or scans the HTML, XML or HTXML code, their derivative works or any future code that is devised, that generates the computer monitor screen copy. The software looks for the UPC numbers or designations or looks for key words, phrases, or descriptors that match with words or phrases located within the software or on the retail web site server 80. These UPC codes or words, phrases, or descriptors describe the product information relevant to the promotions. When a match is made between the UPC code or the words or phrases found from the scan and any available promotions, a graphical symbol representing the promotion offer is shown on the retail web site web page with the corresponding product. Typically, the software filters those promotions that do not have a match on both servers 12 and 80.

When the product with the promotion is selected for purchase by the user (many web sites have a checkout basket or shopping cart etc.), the product moves to the checkout area of the web site and the associated promotions follow. At the checkout area an accounting of the products and promotional offers occurs. A typical sequence is that a subtotal for all selected products is displayed along with a listing of the promotional offers and a deductions of the total of all the promotions that correspond with the selected product, and a total, less promotions. The last total is the amount paid by the user on computer 11. The sum of the promotions involved in the transaction is noted in the retail software accounting system and is relayed via the Internet or other network to the coupon issuing server 12 as indicated by arrow 84. The coupon issuing server records the amount sent by the retail web site server 80 and the identifier in order to provide for payments via check or other transfer through a financial institution 87, as indicated by arrow 86. Periodic contact between the coupon issuing server 12 and the retail web site server 80 takes place via the Internet or other network to provide new promotions and remove expired promotions. This e-commerce retail web site distribution arrangement allows for a complete electronic transaction with no paper involved or printing of coupons.

### User Places Promotion Viewing Software

FIG. 8 illustrates an embodiment of a user placed promotion distribution arrangement. In this arrangement the coupon issuing web site can offer its promotion viewing software to the user to install on the user's computer 1, and through this software, view independent recipe and product web sites and download available promotions related to the recipe ingredients and products.

When the user begins a viewing session using the coupon issuing software, the software residing on the user's computer 11 contacts the coupon issuing server 12, as indicated by arrow 92, through the Internet or other link and requests information regarding the currently available promotions. The server 12 sends back the information to the user's computer as indicated by arrow 94. The user can then proceed to view the recipe and product web sites. As discussed above, the software can scan the HTML, XML, or HTXML code or their derivative works or any future code that is devised, that generates the computer monitor screen copy. These scans look for key product category identifiers such as, but not limited to words and phrases. When these identifiers are found that match existing promotions, the matching graphical symbols representing the available promotions are shown on the computer 11 with the corresponding recipe or product. The user is then able to select the offers that the user wants. These selected offers are temporarily stored on the user's computer 11. At the end of the viewing session, the viewer requests that the promotions be printed on the user's printer (not shown). The viewing software then contacts the coupon issuing server 12, as indicated by arrow 95, containing the promotions and requests, as indicated by arrow 96, that these promotions be sent from the server 12 back to the computer 11 for printing on the user's printer using the secure coupon printing software as discussed above. This software can be turned on/off by the user. Alternatively, the web sites can have a triggering device, offered by the coupon issuing server's operator to turn the program on and off.

### Competing Offers and Tracking

The computer program developed for the coupon issuing system can have the ability to track the buying habits of the people using the individual computers and suggest coupons or other promotions for products that compete with those that they have purchased previously. In addition, when a consumer has selected a coupon to print, the software has the ability to suggest to the consumer other coupons available in competing products.

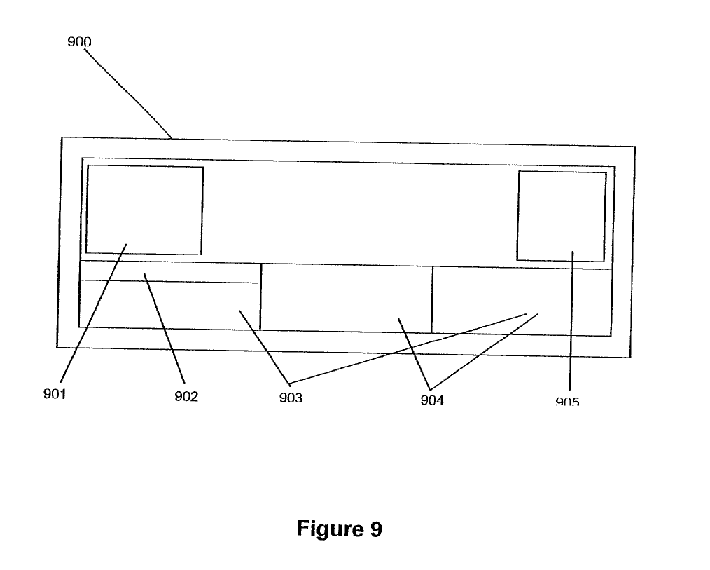

FIG. 9 illustrates an embodiment of a network coupon 900 having security features. This coupon 900 illustrates an embodiment that can be utilized with any of the distribution arrangements discussed above. The coupon 900 includes the amount 901 of the offer and the duration 902 that the offer lasts. The unique serial number 903 for the back end security is also included. The serial number 903 is also used to alert users that the coupon is fraud resistant and copies should be avoided. The UPC code 904 is also included. Finally, an implementation of the graphical symbol 905 to accept and download the coupon 900 is shown. As discussed above, any icon, symbol or graphical element or link can be used to accept and print the coupon.

### Coupon Misredemption Control

Several references have been made to coupon misredemption. In particular, a general overview of Back End Security was discussed above. The following description discusses several embodiments of systems and methods for the prevention and control of misredeemed coupons.

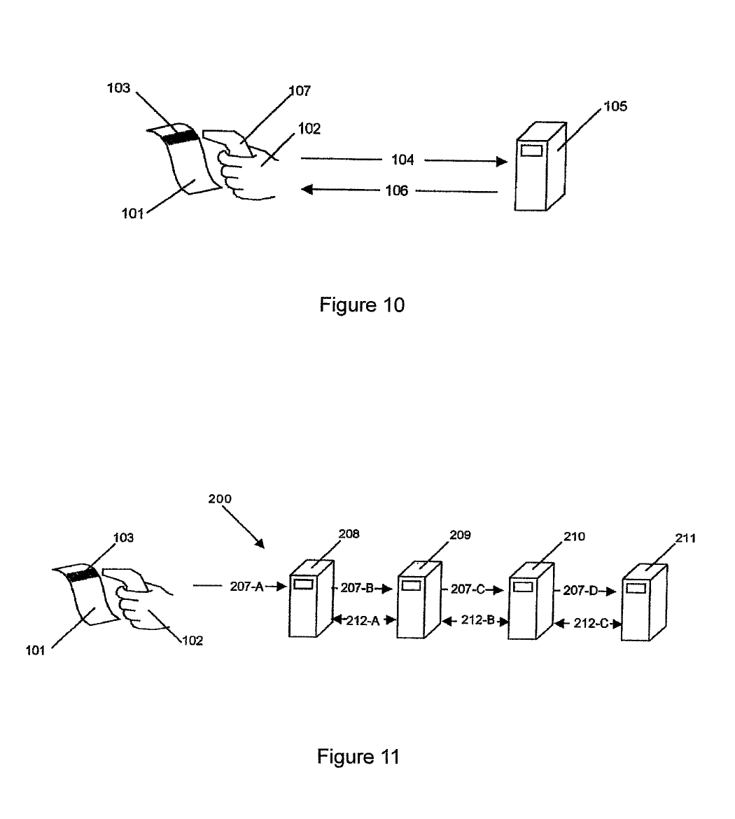

FIG. 10 illustrates an embodiment of a promotion misredemption control system 100. A printed promotion 101, such as a coupon, is presented by a redeeming customer to a promotion receiver 102, such as a store clerk. The promotion 101 has printed on it a bar code 103 that contains a unique identifier or serial number (as described above) that uniquely identifies the promotion 101. Using bar code scanning equipment 107, the receiver 102 scans, as indicated by arrow 104, the information contained in the bar code 103 into a store computer 105 or any other equipment adapted to capture the information. The computer 105 includes a process in its memory (not shown) that is able to download the scanned data and store it in a storage device (not shown) on the computer 105. The process stores the promotion's identifier or serial number on the computer 105 for an indefinite period on a database located on the storage device. The process also associates that identifier or serial number with the promotion 105.

Should another promotion with an identical identifier or serial number contained in its bar code be presented to the receiver 102 (or other receiver at the same store location) at a later date, the process compares the identifier or serial number with the database of identifiers and serial numbers that have previously been scanned by the scanning equipment 107 (or other scanning equipment in the store). If the process matches the new identifier or serial number with an identifier or serial number in the database, then the process generates a signal indicating that a match has been found (as indicated by arrow 106). The signal is transmitted to the receiver 102. When the process finds that the identifier has been matched in the database, the receiver then knows that the promotion has been presented before because the process uniquely associated the promotion with the identifier. Therefore, the receiver 102 knows that the promotion 101 was not released by the customer during a previous visit, the promotion 101 was copied, or the promotion 101 was otherwise fraudulently reproduced by the customer. The receiver 102 has the option to reject the promotion 101.

FIG. 11 illustrates another embodiment of a promotion misredemption control system 200. In this embodiment, the customer gives a promotion 101 to a receiver 102 who scans the bar code 103 with scanning equipment as described above. The scanned data is received into a computer 208 that contains a matching process and database as described above. This embodiment contemplates a series of networked computers 209, 210, 211 (including computer 208), through a network 212 (the networking is indicated by arrows 212a, 212b, 212c, 212d). These networked computers 208, 209, 210, 211 can be several computers on a local area network (LAN) in a particular store or a wide area network (WAN) for a chain of stores, or any other type of network. Each of the computers 208, 209, 210, 211 can individually have the ability to scan data. The networked computer 208, 209, 210, 211 can even represent all participating computers connected to the coupon issuing server (described above) and to a wider area network such as the Internet. Each of the computers 208, 209, 210, 211 can individually contain the matching process. Therefore, when the bar code 103 is scanned, the scanned data is transmitted to all the computers 208, 209, 210, 211 (as indicated by arrows 207a, 207b, 207c, 207d) so that each of the processes can search their respective databases to make sure that the promotion 101 was not redeemed at any one of those computers 208, 209, 210, 211. For example, a customer can redeem the promotion 101 at computer 210, which stores the identifier or serial number. The customer can then attempt to take a fraudulent promotion (for example, copied) and try to redeem the copy at either or both of the computers 208, 209, which may be in the same store or in a different location. But since the originating computer scanned and transmitted the data to all of the computers on the network, each of the computers has the unique identifier stored in its database, thereby preventing multiple misredemptions and the same or different locations. The computers can alert each other with a signal (as described above) which is transmitted by arrows 212a, 212b, 212c. Once again, the receiver 102 can reject the promotion.

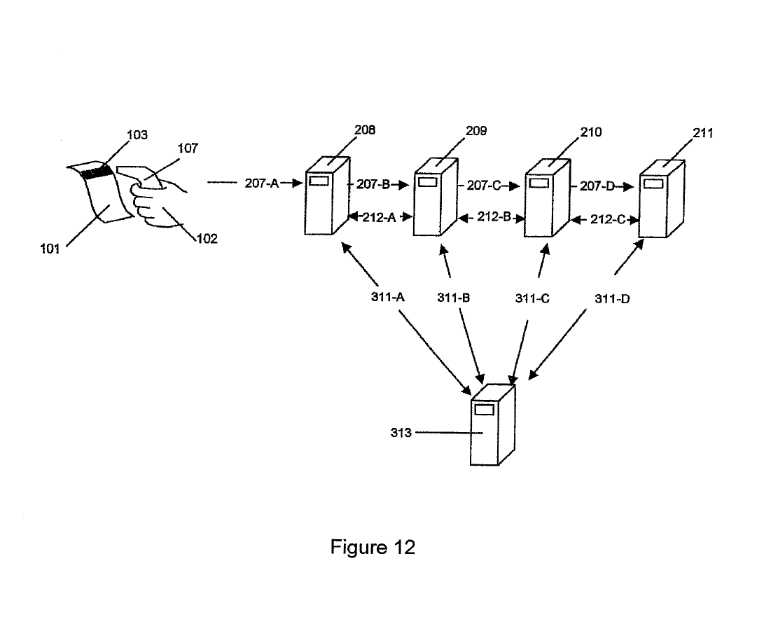

FIG. 12 illustrates still another embodiment of a promotion misredemption control system 300. In this embodiment, a central server 313 is connected to all the computers 208, 209, 210, 211 that are adapted to scan promotions and store the bar code data. However, instead of each computer 208, 209, 210, 211 being responsible for detecting and signaling a fraudulent promotion, the central server 313 processes and stores all of the promotion transactions through a network connection (as indicated by arrows 311a, 311b, 311c, 311d). In this embodiment, any misredeemed promotions is tracked by the central server 313.

When the coupon-issuing server issues a coupon to a consumer's computer, the identifying information assigned to that individual coupon is transmitted to another central server 313 and this identifying information is stored on the server 313. When the consumer redeems this coupon with a receiver (see receiver 102, FIG. 11), the receiver scans the coupon to obtain the identifying information. This identifying information is sent to the receivers' computer (e.g. 208) and then to the central server 313 where it is compared to a stored list of issued coupons that resides on the server 313. If the coupons identifying information does not match any coupon identifying information stored on the central server 313, the central server 313 sends back to the receivers' computer 208, a message that the coupon is invalid. This information is relayed to the coupon receiver so that the coupon redemption may be denied. If the coupon's identifying information does match any coupon identifying information stored on the central server 313, the central server 313 sends back to the receiver's computer 208 a message that the coupon is valid. This information is relayed to the coupon receiver so that the coupon redemption may be accepted.

The server 313 also signals the computers 208, 209, 210, 211 of matching, and therefore fraudulent, identifiers. The server 313 acts as a central processing center for captured coupon information so this information can be recorded, sorted and otherwise processed. This information can be re-sent to the other computers 208, 209, 210, 211 for any further subsequent processing.

The software techniques and methods discussed above can be implemented in digital electronic circuitry, or in computer hardware, firmware, software, or in combinations of them. Apparatus may be implemented in a computer program product tangibly embodied in a machine-readable storage device for execution by a programmable processor; and methods may be performed by a programmable processor executing a program of instructions to perform functions by operating on input data and generating output. Further embodiments may advantageously be implemented in one or more computer programs that are executable on a programmable system including at least one programmable processor coupled to receive data and instructions from, and transmit data and instructions, to a data storage system, at least one input device, and at least one output device. Each computer program may be implemented in a high level procedural or object-oriented programming language, or in assembly or machine language, which can be compiled or interpreted. Suitable processors include, by way of example, both general and special purpose microprocessors, generally, a processor receives instructions and data from read-only memory and or RAM. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing may be supplemented by, or incorporated in, specially designed application specific integrated circuits (ASICs).

Therefore, the foregoing is considered as illustrative only of the principles of the invention. Further, various modifications may be made of the invention without departing from the scope thereof and it is desired, therefore, that only such limitations shall be placed thereon as are imposed by the prior art and which are set forth in the appended claims.

What is claimed is:

1. A promotion misredemption control system, comprising:
a device adapted to receive promotion data; and
a process located on the device having instructions to:
receive and store the promotion data on the device;
compare the promotion data with previous data; and
generate a signal if a misredemption is detected.

2. The system as claimed in claim 1, wherein the device is a computer on a network.

3. The system as claimed in claim 2, wherein a central server is connected to the network.

4. The system as claimed in claim 4, wherein the previous data is in the computer received from the central server.

5. The system as claimed in claim 1, wherein the signal is generated if the promotion data matches the previously stored data.

6. A misredemption control system, comprising:
a central server connected to a network;
at least one additional computer connected to the network; and
a database connected to the network, the database including promotional information.

7. The system as claimed in claim 6 further comprising copies identifying information data stored in the database.

8. The system as claimed in claim 7, wherein the computer is adapted to receive identifying information.

9. The system as claimed in claim 8, wherein the server is adapted to receive the identifying information from the computer and compare the identifying information to the copy of the identifying information.

10. The system as claimed in claim 9, wherein the server is adapted to generate a message for the computer that the identifying information has matched the copy of the identifying information.

11. The system as claimed in claim 10, wherein the computer is adapted to generate a misredemption signal based on the message.

12. A method for the prevention of promotion misredemption, comprising:
providing identifying information on a promotion;
storing a copy of the identifying information;
distributing the promotion;
receiving the identifying information when the promotion is presented for redemption; and
comparing the identifying information to the copy of the identifying information.

13. The method as claimed in claim 12 further comprising optionally rejecting the promotion if the identifying information does not match the copy of the identifying information.

14. The method as claimed in claim 12 further comprising optionally accepting the promotion if the identifying information matches the copy of the identifying information.

15. The method as claimed in claim 12, wherein the copy of the identifying information is stored on a central server on a network.

16. The method as claimed in claim 15, wherein the identifying information is received by a computer on a network.

17. The method as claimed in claim 16, wherein the server compares the identifying information to the copy of the identifying information.

18. The method as claimed in claim 17, wherein the server generates a misredemption message if the identifying information and the copy of the identifying information do not match.

19. The method as claimed in claim 18, wherein the computer generates a misredemption signal based on the misredemption message.

20. The method as claimed in claim 12 further comprising generating a message indicating whether the promotion is acceptable for redemption.

21. The method as claimed in claim 12 further comprising generating a signal if a misredemption is detected.
